(19) United States
(12) Patent Application Publication
(10) Pub. No.: US 2011/0203943 A1
(43) Pub. Date: Aug. 25, 2011

(54) PRINTED SORBENTS

(76) Inventors: David J. Perry, East Amherst, NY (US); John M. Sherry, Elma, NY (US)

(21) Appl. No.: 12/711,995

(22) Filed: Feb. 24, 2010

(51) Int. Cl. B65D 81/26; B05D 1/36; B32B 3/22

(52) U.S. Cl. 206/204; 427/258; 427/2.1; 428/195.1

(57) ABSTRACT

The invention generally relates to an absorbent article comprising an absorbent having printed indicia thereon wherein the printing comprises colorant and resin, and a protective coating over the printing.

### CROSS-REFERENCE TO RELATED APPLICATIONS

None.

### STATEMENT REGARDING FEDERALLY SPONSORED RESEARCH OR DEVELOPMENT

Not applicable.

### REFERENCE TO A “SEQUENCE LISTING”

Not applicable.

### BACKGROUND OF THE INVENTION

1. Field of the Invention

The invention relates to printing items that may be utilized in the medical or food industry.

It particularly relates to the printing on absorbent materials utilized in the medical or food industry.

2. Description of Related Art

There is a need for printing on food and medical products in a safe manner. Further, there is a need for printing of these materials in a way that is resistant to erasing of the printing.

The following are related to the printing on food and medical materials is: U.S. Pat. No. 4,933,133 to Yoshida et al., dated Jun. 12, 1990; U.S. Pat. No. 5,344,017 to Wittrock, dated Sep. 6, 1994; U.S. Pat. No. 6,147,140 to Jaeger et al., dated Nov. 14, 2000; and U.S. Pat. No. 6,059,404 to Jaeger et al., dated May 9, 2000.

While there have been methods and articles for printing on food and medical material, there remains of need for an improved method of printing and for a printed absorbent, that has resistance to deterioration of the print.

### BRIEF SUMMARY OF THE INVENTION

### BRIEF DESCRIPTION OF THE SEVERAL VIEWS OF THE DRAWING(S)

The invention generally relates to an absorbent article comprising an absorbent having printing thereon wherein the printing comprises colorant and resin, and a protective coating over the printing.

In another embodiment, the invention relates to the method of forming printing on an absorbent product comprising providing an absorbent product, printing an ink in machine or human eye readable manner on the absorbent product, and overcoating the printed readable information with an overcoat layer.

### DETAILED DESCRIPTION OF THE INVENTION

The invention has numerous advantages over prior processes and articles. The invention provides a protective and safe coding for food and medical products. The invention provides a low-cost way of marking both absorbent packets and canisters, which contain multiple numbers of absorbent packs.

It is well known that materials may be provided in food and medical packaging which absorbent water, oxygen or other materials that would be harmful to the long-term storage of food and medicine. Typical of such patents are U.S. Pat. No. 6,436,872 to McKedy, dated Aug. 20, 2002; U.S. Pat. No. 5,262,375 to McKedy, dated Nov. 16, 1993; U.S. Pat. No. 6,667,273 to Cullen et al., dated Dec. 23, 2003; U.S. Pat. No. 6,558,571 to Powers, dated May 6, 2003; and U.S. Pat. No. 5,332,590 to McKedy, dated Jul. 26, 1994.

In use of such materials it is helpful if they can be clearly identified so that the right absorbent goes into each food or medical package. This invention provides a way of identifying absorbent packs for food and medical packages that absorb water vapor, oxygen or other gaseous materials, such as acids or solvents.

The invention finds a preferred use in printing on plastic canisters or capsules that have vapor permeable end caps. An example of such a product is “Sorbicap” canisters from Multisorb Technologies. The canister is a hard plastic such as polyethylene and the absorbent absorbs moisture and odors. The invention printing is carried out by the pad printing technique with the materials of Example 1 below. The printing will survive having Scotch® brand adhesive tape applied to the printing and then removed and also being rubbed with a thumb. The canisters are illustrated in U.S. Pat. Nos. 5,81 5,438; 5,894,490; and 7,542,272, hereby incorporated by reference.

The invention is accomplished by printing with a medical or food safety onto an absorbent pack. The term pack as used herein is intended to indicate the individual container of absorbent materials that would be put in a food or medical package. The individual packs may be made of any suitable material. Typically, the sheet material forming the container (sachet) will pass gas but not liquids. Suitable materials are fabrics that are barriers to liquids but not vapor such as microperforated, spun bond, or microporous sheetssheet materials.

The sheet materials are typically formed of a polymer resin such as polyethylene, polypropylene, or other polyolefin. Printing on such materials may be difficult. Therefore it is preferred that the materials be treated to activate the surfaces such as by corona treatment. Such treatment aids in binding of the ink to the vapor permeable sheet.

The printing ink utilized generally comprises a solvent, resin, and a dye and/or pigment. Any dye or pigment that is safe medical or food use is suitable. They FDA has approved many dyes and pigments for use with food. Suitable dyes are many natural dyes, copper dyes and carbon containing dyes. Other suitable dyes may be found in U.S. Pat. Nos. 6,147,140 and 6,059,404, both to Jaeger et al., hereby incorporated by reference.

The resin utilized in the ink may be any resin suitable for exposure to food or medical products. Typical such materials are esters and polyurethanes known in the medical and food packaging arts as safe. Other suitable resins include a resins comprising polytetrafluorethylene and polyethylene wax.

The protective coat may be any suitable resin. The resin suitable for the protective coat includes the resin utilized in the inks. The protective coat protects the human eye or machine-readable indicia information in the ink from being removed. Generally, these materials may be the polyethylene wax materials, polyurethanes and polyesters suitable for use in foods and medical materials. The protective coating needs to be strong enough to prevent removal by food products, pills, or packages of these materials.

Any printing technique may be utilized in the printing of the indicia of the invention. Included are xerographic techniques, inkjet, roll coating and pad printing.

### EXAMPLES

The following examples are intended to be illustrative and not exhaustive in setting forth all embodiments of the invention. Parts and percentages are by weight unless otherwise indicated.

### Example 1

A Tyvek sachet of oxygen containing absorbent material comprising iron, sodium bicarbonate and sodium chloride was printed utilizing a resin, colorant and solvent ink of product number comprising No-Tox Lon-1743 NT-24 (blue). This printing was overcoated with NoTox Lon-1916 NT26 resin a solvent protective coating. These materials are available from the Colorcon Company.

### Example 2

The process of example, one was repeated but the ink No-Tox Lon-2297 NT-24 (blue) was substituted for the ink of Example 1.

### Example 3

The ink of Example 6 of U.S. Pat. No. 6,059,404 was printed as indicia on the sachet of Example 1. A continuous protective coat of the ink of example 7 of U.S. Pat. No. 6,059,404 was printed over the indicia as a continuous coat. This was found to provide a suitable protected print of indicia for use in the food industry.

1. An absorbent article comprising an absorbent having printed indicia thereon wherein the printing comprises colorant and resin, and a protective coating over the printing.

2. The article of claim 1, wherein the absorbent comprises container containing absorbent powder.

3. The article of claim 2, wherein the container comprises a sachet.

4. The article of claim 2, wherein the surface of the container comprises high-density polyethylene that has been corona treated.

5. The article of claim 4, wherein the surface of the high-density polyethylene has a dyne level of over 40.

6. The article of claim 1, wherein the absorbent comprises a plastic canister containing absorbent and having vapor pervious end caps.

7. The article of claim 1, wherein the printed indicia is on individual packs.

8. The article of claim 6, wherein the printed indicia is on the surface of the canister

9. The article of claim 2, wherein the container contains iron.

10. The method of printing on a absorbent product comprising providing an absorbent product container, printing ink indicia in machine or human eye readable form on the absorbent product, and overcoating the printed indicia with an overcoat layer.

11. The method of claim 10, wherein the absorbent product may be a container for individual packs of absorbent product.

12. The method of claim 11, wherein the printing is on individual packs of absorbent material.

13. The method of claim 10, wherein the ink is approved for food or medical use.

14. Method of claim 10, wherein the ink comprises solvent, resin, and colorant.

15. The method of claim 14, wherein the solvent is selected from the group comprising xylene, mineral oil, cumene, 1,3,5-trimethyl benzene, 1,2,4-trimethyl benzene, methyl propylbenzene, and mixtures thereof.

16. Method of claim 10, wherein the colorant comprises a blue dye approved for use in food packaging.

17. The method of claim 14, wherein the resin is selected from the group consisting of polyethylene wax, tetrafluoroethylene, and mixtures thereof.

18. A method of claim 14, wherein the colorant comprises a copper containing colorant.

19. The method of claim 14, wherein is between four and 14% by weight of pigment is present in the ink.
